(19) United States
(12) Patent Application Publication
(10) Pub. No.: US 2023/0144262 A1
(43) Pub. Date: May 11, 2023

(54) PHOTO-THERMO-ACOUSTIC MECHANISM-BASED POWER MEASUREMENT APPARATUS AND MEASUREMENT METHOD FOR TERAHERTZ WAVE AT ROOM TEMPERATURE

(71) Applicant: Nankai University, Tianjin (CN)

(72) Inventors: Weiwei LIU, Tianjin (CN); Tingyuan WANG, Tianjin (CN); Nan ZHANG, Tianjin (CN); Lanjun GUO, Tianjin (CN)

(73) Assignee: Nankai University, Tianjin (CN)

(21) Appl. No.: 17/979,501

(22) Filed: Nov. 2, 2022

(30) Foreign Application Priority Data
Nov. 8, 2021 (CN) 202111310845.7

(51) Int. Cl. G01N 21/3581; G02F 1/01

(52) U.S. Cl. CPC G01N 21/3581; G02F 1/0126; G02F 2203/13

(57) ABSTRACT

The present disclosure relates to the technical field of terahertz (THz) wave measurement and relates to a photo-thermo-acoustic mechanism-based power measurement apparatus and measurement method for a terahertz wave at room temperature. The apparatus includes a terahertz wave power modulation component, a photo-thermo-acoustic conversion device, and an acoustic wave measurement component. In the present disclosure, the THz absorbing substance having a photo-thermo-acoustic effect is used as the photo-thermo-acoustic conversion device. A power-modulated terahertz wave is converted into an acoustic wave pulse by means of the photo-thermo-acoustic mechanism. The acoustic wave measurement component measures the acoustic wave pulse. A peak-to-peak value of a pulse of the measured acoustic wave is proportional to the power of the terahertz wave, thereby implementing the fast broadband measurement of the terahertz wave power at room temperature.

### CROSS REFERENCE TO RELATED APPLICATION

This patent application claims the benefit and priority of Chinese Patent Application No. 202111310845.7, filed with the China National Intellectual Property Administration on Nov. 8, 2021, the disclosure of which is incorporated by reference herein in its entirety as part of the present application.

### FIELD

The present disclosure relates to the technical field of terahertz wave detection and relates to a photo-thermo-acoustic mechanism-based power measurement apparatus and measurement method for a terahertz wave at room temperature.

### BACKGROUND

A terahertz wave is an electromagnetic wave with a frequency between 0.1 THz and 10 THz, and falls between the frequencies of the microwaves and infrared light. This band of terahertz waves falls within a middle ground of electronics and photonics. The special position in an electromagnetic spectrum where the terahertz wave falls provides many excellent properties and important academic and application prospects. The high penetration of the terahertz wave allows the terahertz wave to penetrate various dielectric materials and non-polar substances. Thus, the terahertz wave can be used for imaging opaque substances and act as an extension of X-ray imaging and ultrasound imaging techniques. The terahertz wave can be employed in non-destructive analysis, such as security inspection and quality inspection. In addition, the low photon energy of the terahertz wave allows the terahertz wave to be suitable for biopsies of biological samples and used as an ideal tool for medical detection of skin cancer, dental caries, etc. In addition, vibrational-rotational energy level transitions of many polar molecules and biomacromolecules fall within the band of terahertz waves, and therefore, the terahertz waves are excellent in identifying materials. According to the spectral fingerprints produced in these transitions, the terahertz wave can detect the composition of an object while detecting the three-dimensional contour of the object, providing a relevant theoretical basis and detection method for drug prohibition, counter-terrorism, explosive ordnance disposal, etc. Furthermore, the terahertz wave has a higher frequency than the electromagnetic wave currently used in wireless communications. Therefore, when using the terahertz wave as a communication carrier, more information can be transmitted per unit time. Therefore, terahertz wave communication has become the development direction of future wireless communication technology.

At present, the development of the terahertz technology is mainly restricted by the principles and technical levels of terahertz emission sources, terahertz detectors, terahertz functional devices. A room-temperature full-bandwidth (0.1 THz to 10 THz) terahertz detector may be used only by means of an incoherent detection method based on the thermal effect and a coherent detection method based on a pump-based detection technology. However, the latter method requires the use of an ultrashort laser pulse source, resulting in a limited application range of the detector. However, the common terahertz detection methods based on the thermal effect require mainly a thermal radiometer, a Golay cell, a pyroelectric detector, etc. Some of these detection methods require a low temperature (such as the thermal radiometer), and some of them have very slow measurement speeds (such as the Golay cell and the pyroelectric detector). Therefore, it is urgent to develop a fast room-temperature full-bandwidth terahertz detector.

### SUMMARY

The present disclosure intends to solve the problem that the existing power measurement methods for a terahertz wave cannot achieve fast room-temperature full-bandwidth terahertz detection. The present disclosure provides a photo-thermo-acoustic mechanism-based power measurement apparatus and measurement method for a terahertz wave at room temperature, and achieves the photo-thermo-acoustic mechanism-based power measurement at room-temperature of the terahertz wave. In a photo-thermo-acoustic conversion process, the terahertz wave is firstly absorbed by means of the inter-band transition and intra-band transition of electrons. Then, the absorbed terahertz wave energy is converted into thermal energy via electron-phonon coupling. Finally, the thermal energy fluctuations caused by the rapid modulation of the terahertz wave drive the generation of an acoustic wave, and the photo-thermo-acoustic conversion is thus implemented. To implement the fast room-temperature broadband measurement, graphene foam is employed in the present disclosure as the photo-thermo-acoustic conversion device.

### Technical Solution of the Present Disclosure

A photo-thermo-acoustic mechanism-based power measurement apparatus for a terahertz wave at room temperature includes a terahertz wave power modulation component, a photo-thermo-acoustic conversion device, and an acoustic wave measurement component. A modulated terahertz wave output from the terahertz wave power modulation component irradiates the photo-thermo-acoustic conversion device. The photo-thermo-acoustic conversion device converts the received modulated terahertz wave into an acoustic wave pulse based on the photo-thermo-acoustic mechanism. Then, the acoustic wave measurement component measures the acoustic wave pulse. The peak-to-peak value of the acoustic wave pulse is proportional to the power of the modulated terahertz wave. The power of the terahertz wave is thus measured.

The material for the photo-thermo-acoustic conversion device is a terahertz absorbing substance having a photo-thermo-acoustic effect, such as graphene foam. The graphene foam preserves the energy band structure, low heat capacity, and high thermal conductivity of graphene. The unique energy band structure of graphene ensures that the incident terahertz wave can be absorbed in both the inter-band transition process and the intra-band transition process. Therefore, graphene has a high absorption rate for terahertz waves. Moreover, the low heat capacity and high thermal conductivity provide graphene with a high thermoacoustic conversion efficiency. Therefore, graphene is an efficient material for the photo-thermo-acoustic conversion. Compared with graphene, the graphene foam has the advantages of a centimeter-scale three-dimensional size with no substrate. The centimeter-level three-dimensional size is in the same size scale of a terahertz wave spot, ensuring sufficient absorption of the terahertz wave to be measured. Furthermore, the graphene foam requires no substrate, the thermal energy would not diffuse into the substrate, so that the acoustic wave generated by the thermoacoustic effect is stronger.

The terahertz wave power modulation component can be an optoelectronic modulation component contained in a terahertz source to be measured, or an external chopper or a semiconductor material irradiated periodically by a modulation light.

The acoustic wave measurement component includes a microphone, an electrical signal adaptor, and a data recording device such as an oscilloscope.

The measurement apparatus provided in the present disclosure can measure the terahertz wave power at room temperature.

The present disclosure also provides a photo-thermo-acoustic mechanism-based power measurement method for a terahertz wave at room temperature, which is implemented by the measurement apparatus, and includes the following steps:

1) transforming a continuous terahertz wave into a modulated terahertz wave after the continuous terahertz wave passes through a terahertz switch formed in the terahertz wave power modulation component;

2) irradiating the surface of the photo-thermo-acoustic conversion device (such as the graphene foam) by the modulated terahertz wave, and absorbing the modulated terahertz wave by the photo-thermo-acoustic conversion device, resulting in a photo-thermo-acoustic effect; and generating an acoustic wave;

3) receiving the acoustic wave and converting same into a voltage signal by the acoustic wave measurement component; amplifying the signal, and displaying a measurement result of the acoustic wave;

4) a peak-to-peak value of the measured acoustic wave pulse being proportional to the power of the modulated terahertz wave, thereby implementing the measurement of the terahertz wave power.

The present disclosure has the following advantages and beneficial effects:

The photo-thermo-acoustic mechanism-based power measurement apparatus and method for a terahertz wave at room temperature according to the present disclosure are used for a broadband, features a simple structure and fast response, require no cooling, and have a large dynamic measurement range. The apparatus can measure the entire terahertz wave band (0.1 THz to 10 THz), and the properties of room temperature and broadband of the apparatus are derived from the broadband absorption, extremely low heat capacity per unit area (HCPUA) and high thermal conductivity of the graphene foam. These properties enable the graphene foam to have excellent terahertz photo-thermo-acoustic conversion efficiency. The measurement apparatus employs a microphone in the auditory range of the human ear as an acoustic wave detector, and such a microphone is cheap and technically matured. Compared with the traditional photothermal effect-based detection method (with a response time of 0.01 s), the response speed of the photo-thermo-acoustic effect-based detection method is increased by 2 to 3 orders of magnitude, which is beneficial to the development of high-speed terahertz communication. The graphene foam used in the measurement apparatus does not require the connection to an antenna or electrode, which saves the process of designing and preparing the electrode and antenna, and brings a high damage threshold to the apparatus, thereby achieving the large dynamic measurement range. In summary, the measurement apparatus is a novel terahertz measurement apparatus which has a simple structure and can measure the terahertz wave power at room temperature.

### BRIEF DESCRIPTION OF THE DRAWINGS

FIG. 1 is a schematic diagram of a measurement apparatus according to one embodiment.

FIGS. 2A-B illustrate waveform (a) of the modulated terahertz wave of the present disclosure and a waveform (b) of an acoustic wave generated from the terahertz wave.

FIG. 3 is a schematic diagram of the principle of the photo-thermo-acoustic effect of the present disclosure.

FIG. 4 is a schematic diagram of the dependence between the peak-to-peak value of acoustic pressure and the terahertz power of the present disclosure.

Reference numerals in the drawings: 1, continuous terahertz wave source; 2, first off-axis parabolic mirror; 3, second off-axis parabolic mirror; 4, light source; 5, reflector; 6, semiconductor; 7, photo-thermo-acoustic conversion device; 8, microphone; 9, electrical signal adaptor; and 10, oscilloscope.

### DETAILED DESCRIPTION

Hereinafter, the technical solutions of the present disclosure will be completely described with reference to the accompanying drawings. These drawings are simplified schematics for illustrating the basis structure of the present disclosure. The described embodiments are merely some rather than all of the embodiments of the present disclosure. All other embodiments obtained by those of ordinary skill in the art based on the embodiments of the present disclosure without creative efforts should fall within the protection scope of the present disclosure.

The following description of the exemplary example is merely illustrative, and not intended to limit the present disclosure and application or use thereof in any way. Any specific values should be construed merely illustrative and not as a limitation. Thus, other examples of the embodiments may have different values.

### Embodiment 1

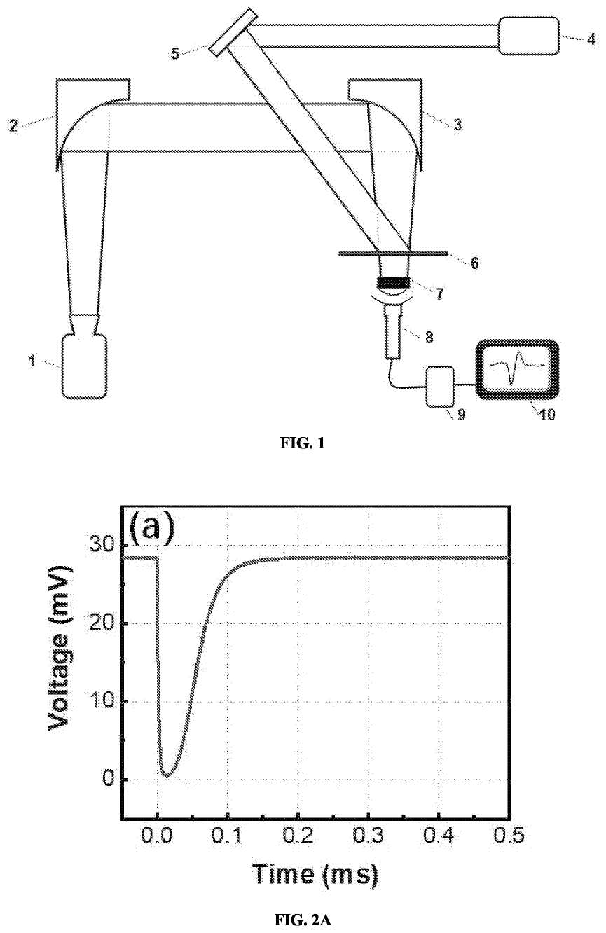

The present disclosure provides a photo-thermo-acoustic mechanism-based power measurement apparatus for a terahertz wave at room temperature. The apparatus includes a terahertz wave power modulation component, a photo-thermo-acoustic conversion device, and an acoustic wave measurement component. The specific structure of the apparatus according to the embodiment is as illustrated in FIG. 1. The terahertz wave power modulation component generates an amplitude-modulated terahertz wave. The modulated terahertz wave irradiates the photo-thermo-acoustic conversion device to be converted into an acoustic wave, and is then acquired by the acoustic wave measurement component.

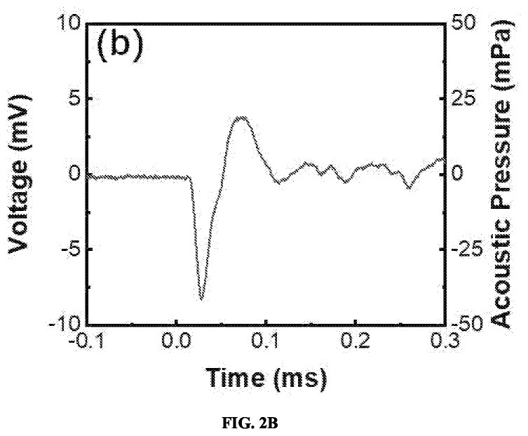

As shown in FIG. 1, the terahertz wave power modulation component includes a continuous terahertz wave source, a light source, and a semiconductor. Modulation light emitted by a light source 4 passes through a reflector 5 and irradiates the surface of a semiconductor 6; and then, the concentration of photogenerated carriers on the surface of the semiconductor would change during the light irradiation, thereby changing the transmittance of the terahertz wave to the semiconductor. Therefore, the transmittance of the terahertz wave is periodically changed by means of the modulation light. When the terahertz wave emitted by the continuous terahertz wave source 1 propagates through the first and second off-axis parabolic mirrors 2 and 3 to the region on the surface of the semiconductor 6 irradiated by the modulation light, the terahertz wave is modulated by the semiconductor into the amplitude-modulated terahertz wave. According to the embodiment, the terahertz wave is from a 0.1 THz continuous source, irradiating the semiconductor surface at a power of about 22 mW. The semiconductor is an intrinsic silicon wafer having a diameter of about 100 mm and a thickness of 500 μm. The modulation light is a femtosecond laser having a pulse width of 50 fs, a center wavelength of 800 nm, and a repetition rate of 50 Hz. The diameter of the spot irradiating the silicon wafer is about 2 cm. The diameter of the terahertz wave irradiating the semiconductor surface is about 1.9 cm. The waveform of the modulated terahertz wave is shown in FIG. 2A.

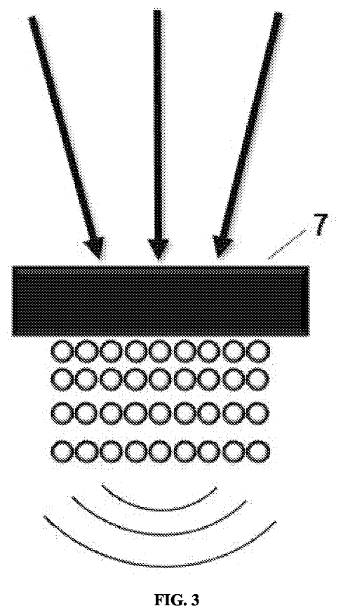

The photo-thermo-acoustic conversion device 7 performs the photo-thermo-acoustic conversion based mainly on the photo-thermo-acoustic mechanism. According to the photo-thermo-acoustic principle, light absorbed by a material would be converted into heat, which will then heat a surrounding air layer to expand the air layer; correspondingly, when the light disappears, the surrounding air layer will cool and compress; the expansion and compression of the air layer produces the acoustic waves. Therefore, the acoustic waves can only be generated when the light energy changes abruptly, and the acoustic waves cannot be generated under constant light energy. The photo-thermo-acoustic mechanism is as illustrated in FIG. 3. In order to obtain a higher photothermal conversion coefficient, the photo-thermo-acoustic conversion material requires a lower heat capacity per unit area (HCPUA). The photo-thermo-acoustic conversion device used in the present disclosure is a two-dimensional material, such as the graphene foam. Graphene, which is the thinnest known material, has an extremely low HCPUA. Compared with the single-layer graphene, graphene foam is three-dimensional and can stand on its own, without requiring a substrate for support. Therefore, the energy does not dissipate to the substrate, and the graphene foam can more effectively improve photo-thermo-acoustic conversion efficiency. The graphene foam according to the embodiment is a cylinder with a diameter of about 10 mm and a thickness of about 1.5 mm

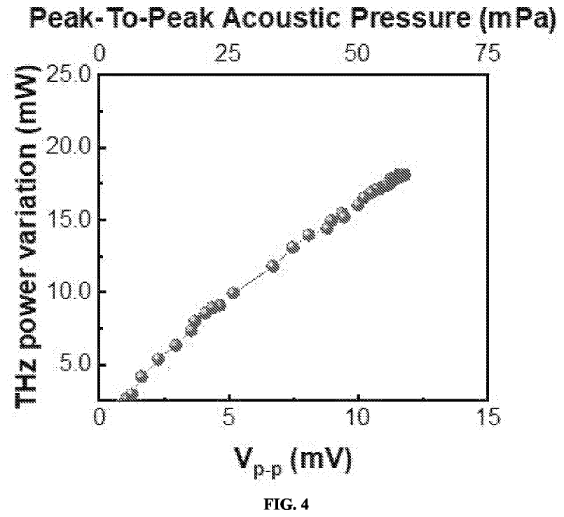

The acoustic wave measurement component is mainly composed of a microphone 8, an electrical signal adaptor 9 and an oscilloscope 10. The microphone converts an acoustic wave signal into an electrical signal, and the electrical signal adaptor would moderately amplify the signal while supplying power to the microphone, and then the signal is displayed on the oscilloscope. According to the embodiment, since the amplitude of the modulated terahertz wave irradiating the surface of the graphene foam changes for a very short time, less than 15 μs, only one acoustic wave signal is generated for one amplitude change, as shown in FIG. 2B. The response time of the acoustic wave is about 30 μs, including a fall time, about 8 μs and a rise time, about 19 μs. The response time is much shorter than that of a commercial photothermal terahertz detector. By calibrating the responsivity, the peak-to-peak value of the acoustic wave pulse can be converted into THz power. As illustrated in FIG. 4, the terahertz power corresponding to the peak-to-peak acoustic pressure of different acoustic wave pulses shows that there is a linear relationship between the terahertz power and the peak-to-peak acoustic pressure, and the responsivity obtained by fitting is about 3.26 Pa/W. Therefore, the THz power corresponding to the peak-to-peak acoustic pressure of 59 mPa acoustic wave in FIG. 2B is about 18.1 mV. The microphone is cylindrical with a diameter of about 7 mm and a length of about 53 mm. The distance between the front surface of the microphone and the back surface of the graphene foam is about 2 mm, and the detection frequency range of the microphone is 4 Hz-100 kHz. Herein, the magnification of the electrical signal adaptor is 100. The microphone, the electrical signal adaptor and the oscilloscope are connected by a coaxial cable.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

We claim:

1. A photo-thermo-acoustic mechanism-based power measurement apparatus for a terahertz wave at room temperature, comprising a terahertz wave power modulation component, a photo-thermo-acoustic conversion device, and an acoustic wave measurement component; wherein the terahertz wave power modulation component is configured to irradiate the photo-thermo-acoustic conversion device with an output modulated terahertz wave; the photo-thermo-acoustic conversion device is configured to convert the received modulated terahertz wave into an acoustic wave pulse on the basis of the photo-thermo-acoustic mechanism; the acoustic wave measurement component is configured to measure the acoustic wave pulse; and a peak-to-peak value of the acoustic wave pulse is proportional to power of the modulated terahertz wave, thereby implementing the measurement of the terahertz wave power.

2. The photo-thermo-acoustic mechanism-based power measurement apparatus for a terahertz wave at room temperature according to claim 1, wherein the photo-thermo-acoustic conversion device is made of a terahertz absorbing substance having a photo-thermo-acoustic effect.

3. The photo-thermo-acoustic mechanism-based power measurement apparatus for a terahertz wave at room temperature according to claim 2, wherein the terahertz absorbing substance having a photo-thermo-acoustic effect is graphene foam.

4. The photo-thermo-acoustic mechanism-based power measurement apparatus for a terahertz wave at room temperature according to claim 1, wherein the terahertz wave power modulation component is an optoelectronic modulation component of a terahertz source to be measured, or an external chopper or a semiconductor material irradiated periodically by a modulation light.

5. The photo-thermo-acoustic mechanism-based power measurement apparatus for a terahertz wave at room temperature according to claim 1, wherein the acoustic wave measurement component comprises a microphone, an electrical signal adaptor, and a data recording device.

6. The photo-thermo-acoustic mechanism-based power measurement apparatus for a terahertz wave at room temperature according to claim 1, wherein the apparatus measures the power of the modulated terahertz wave at room temperature by measuring the peak-to-peak value of the acoustic wave pulse.

7. A photo-thermo-acoustic mechanism-based power measurement method for a terahertz wave at room temperature, employing the apparatus according to claim 1, and comprising the following steps:
transforming a continuous terahertz wave into a modulated terahertz wave after the continuous terahertz wave passes through a terahertz switch in the terahertz wave power modulation component;
irradiating a surface of the photo-thermo-acoustic conversion device by the modulated terahertz wave, and absorbing the modulated terahertz wave by the photo-thermo-acoustic conversion device, resulting in a photo-thermo-acoustic effect; and generating an acoustic wave;
receiving the acoustic wave and converting same into a voltage signal by the acoustic wave measurement component; amplifying the voltage signal, and displaying a measurement result of the acoustic wave;
a peak-to-peak value of a pulse of the measured acoustic wave being proportional to the power of the modulated terahertz wave, thereby implementing the measurement of the terahertz wave power.

8. The method according to claim 7, wherein the photo-thermo-acoustic conversion device is made of a terahertz absorbing substance having a photo-thermo-acoustic effect.

9. The method according to claim 8, wherein the terahertz absorbing substance having a photo-thermo-acoustic effect is graphene foam.

10. The method according to claim 7, wherein the terahertz wave power modulation component is an optoelectronic modulation component of a terahertz source to be measured, or an external chopper or a semiconductor material irradiated periodically by a modulation light.

11. The method according to claim 7, wherein the acoustic wave measurement component comprises a microphone, an electrical signal adaptor, and a data recording device.

12. The method according to claim 7, wherein the apparatus measures the power of the modulated terahertz wave at room temperature by measuring the peak-to-peak value of the acoustic wave pulse.
